(19) United States
(12) Patent Application Publication
(10) Pub. No.: US 2006/0256335 A1
(43) Pub. Date: Nov. 16, 2006

(54) Optical beam-shaper

(75) Inventor: Yong Qin Chen, San Jose, CA (US)

Correspondence Address: DAVID W. HIGHET, VP AND CHIEF IP COUNSEL;BECTON, DICKINSON AND COMPANY, 1 BECTON DRIVE, MC 110, FRANKLIN LAKES, NJ, 07417-1880, US

(73) Assignee: Becton, Dickinson and Company, Franklin Lakes, NJ (US)

(21) Appl. No.: 11/417,950

(22) Filed: May 3, 2006

Related U.S. Application Data
(60) Provisional application No. 60/680,729, filed on May 13, 2005.

(51) Int. Cl. G01J 4/00

(52) U.S. Cl. 356/369

(57) ABSTRACT

The present invention provides beam-shaping optics for transforming an approximately gaussian beam profile into a (nearly) uniform distribution over a specified spot area. The beam-shaping optics provide significant advantages over existing beam-shapers in that they are less sensitive to variations in the input beam profiles and can be used over a range of frequencies.

### CROSS REFERENCE TO RELATED APPLICATIONS

This application claims priority to U.S. provisional application No. 60/680,729, filed May 13, 2005, which is incorporated herein by reference.

### BACKGROUND OF THE INVENTION

1. Field of the Invention

The present invention relates to the field of optics and, in particular, to laser optics.

2. Description of Related Art

Particle analyzers, such as flow and scanning cytometers, are well known analytical tools that enable the characterization of particles on the basis of optical parameters such as light scatter and fluorescence. In a flow cytometer, for example, particles such as molecules, analyte-bound beads, or individual cells in a fluid suspension are passed by one or more detectors in which the particles are exposed to an excitation light, typically one or more lasers, and the light scattering and fluorescence properties of the particles are measured. Each particle, or subcomponents thereof, may be labeled with a multiplicity of spectrally distinct fluorescent dyes. Typically, detection is carried out using a multiplicity of photodetectors, one for each distinct dye to be detected. Both flow and scanning cytometers are commercially available from, for example, BD Biosciences (San Jose, Calif.). A full description of flow cytometers is provided in Shapiro, 2003, Practical Flow Cytometry (John Wiley and Sons, Inc. Hoboken, N.J.), and in the references cited therein, all incorporated herein by reference.

In a typical flow cytometer, the laser excitation light having an approximately gaussian beam profile is focused into an elliptical focal spot to illuminate the core stream (the fluid stream containing the particles to be analyzed), wherein the major axis of the ellipse is perpendicular to the flow. In order to obtain uniform illumination across the width of the core stream, the focal spot is widened, which results in a significant portion of the beam being wasted. A larger fraction of the beam energy could be used if the beam profile were reshaped into a “top hat” beam profile in which the beam is relatively uniform over the width of the core stream and drops off rapidly (i.e., has steep shoulders) outside the core stream.

The use of a beam-shaper to transform the near-gaussian intensity profile of laser beam into a uniform or near-uniform profile distribution of intensity over a given spot area (a top-hat profile) has been described. For example, diffractive optics have been used to transform a near gaussian beam profile to a top-hat beam profile using a single beam shaping element with only minimal power losses. However, beam-shapers using diffractive optics have distinct disadvantages in particular applications because of their sensitivity to the input beam profile and because the beam shaping is wavelength-dependent.

In practice, many commercially available lasers exhibit considerable variability in the output beam profile, which may be only approximately gaussian in profile. The variability in the output beam profile results in poor beam shaping using diffractive optics.

Additionally, diffractive optics need to be matched to the beam wavelength. Some lasers, e.g., semiconductor lasers, typically emit over a 10 nm bandwidth. The breadth of the laser bandwidth results in poor beam shaping using diffractive optics.

### BRIEF SUMMARY OF THE INVENTION

The present invention provides beam shaping optics for modifying an input beam intensity profile by broadening the central, higher-intensity region of the profile while maintaining a fast intensity fall-off at the outer regions of the profile. In preferred embodiments, the beam shaping optics of the present invention transforms an approximately gaussian beam profile into an approximation of an ideal top-hat profile, having a uniform, or nearly uniform, distribution over a specified spot area.

The beam-shaping optics of the present invention comprise at least one beam-splitting element that splits the input beam into divergent output beams having overlapping intensity profiles such that a single combined output beam resulting from the superposition of the divergent output beams has, along the divergence axis, a broadened central, higher-intensity region while maintaining a relatively fast intensity fall-off at the outer regions of the profile. In preferred embodiments, the combined output beam is focused using a focusing lens to a desired illumination spot size.

In some embodiments of the present invention, the beam-shaping optics comprise a plurality of beam-splitting elements. The plurality of beam-splitting elements split the light into a greater multiplicity of output beams such that a single combined beam having the desired intensity profile is formed from the superposition of the output beams. The formation of the final combined output beam from a greater number of component output beams enables more refined reshaping of the beam and closer approximations to a desired beam profile, such as an ideal top-hat profile.

The plurality of beam-splitting elements may be oriented such that the multiplicity of output beams diverge along a single axis, resulting in a combined output beam that is reshaped along a single axis. Alternatively, the plurality of beam-splitting elements may be oriented such that the output beams diverge along two, preferably orthogonal axes, resulting in a combined output beam that is reshaped along the two axis. Combinations of these embodiments enable more refined reshaping of the beam profile in both profile axes.

In preferred embodiments, the beam shaping optics of the present invention are based on the properties of uniaxial birefringent crystals. In particular, the preferred beam-shaping optics of the present invention comprise a beam-splitting element that is a wedge of a birefringent material. The wedge angle is chosen such that the divergent output beams are overlapping, and the superposition of the output beams has the desired intensity profile. For example, assuming an input beam having an approximately gaussian intensity cross-section, the wedge beam-splitting element splits the input beam into two divergent beams, each have an approximately gaussian cross-section. Preferably, a focusing lens is used to focus the diverging output beam to a desired physical spot size. The superposition of two overlapping beams having gaussian profiles provides an output beam having a broadened center region having relatively high intensity, while retaining nearly the same intensity fall-off of the component beams.

An advantage of using wedges of a birefringent material as beam-splitting elements is that the divergent output beams are polarized in directions perpendicular to each other. The orthogonal polarizations minimize undesired coherent interferences between the output beams. This property of the beam-shapers of the present invention represents a significant advantage over previously described beam-shapers.

Although, in preferred embodiments, the beam-splitting elements consist of a wedge of a birefringent material, it will be clear to one of skill in the art that other optical elements, such as a diffraction grating beam-splitting element can be used, either alone or in combination with elements made from birefringent material. It will also be clear that certain advantages provided by the preferred beam-splitting elements, e.g., the minimization of undesired coherent interferences between the split beams, result from the properties of birefringent materials and, thus, enhanced performance is achieved using the preferred embodiments.

In some embodiments of the present invention, the beam-shaping optics comprise a plurality of beam-splitting elements, wherein at least one, but preferably all, of the beam-splitting elements are wedges of a birefringent material.

In preferred embodiments, the beam-shaper comprises plurality of beam-splitting elements that are wedges of a birefringent material, and at least one polarization-modifying element that is positioned in the light path between two beam-splitting elements. A beam-splitting element that is a wedge of a birefringent material, in addition to splitting an input beam into two divergent beams, also results in orthogonal linear polarization of the output beams. The polarization-modifying element functions to modify the polarization of the output beams leaving a beam-splitting element prior to passing through a subsequent beam-splitting element.

The polarization-modifying element can be any element that modifies the polarization of the linearly polarized beams produced by the first beam-splitting element into unpolarized, circularly polarized, or linearly polarized beams, or some combination thereof. The polarization-modifying element preferably is a polarization-rotating element, e.g., a half-wave plate made from a birefringent material, although other polarization-modifying optical elements can be used.

Using a preferred beam-shaper comprising a first wedge of birefringent material, a polarization-modifying element, and a second beam-splitting element, an input beam having an approximately gaussian intensity cross-section is split first into two intermediate divergent beams by the first beam-splitting element, each have an approximately gaussian cross-section and linearly polarized at right angles to each other. The resulting intermediate beams then are passed through a polarization-modifying element to produce some combination of unpolarized, circularly polarized, or linearly polarized beams having equal, or approximately equal, projections onto the polarization planes of the second beam-splitting element. Each of the two intermediate beams is split into two divergent beams by the second beam-splitting element, thus resulting in two divergent output beams polarized at right angles to each other for each of the two intermediate beams. Thus, four divergent output beams, each with an approximately gaussian beam profile, are produced. The wedge elements are selected such that the four individual output beams are overlapping, and the recombined beam resulting from the superposition of the four individual output beams has a desired approximation to an ideal top-hat beam profile.

The relative intensity of the output beams split from a linearly polarized input beam is determined by relative projection of the input beam onto the polarization planes of the following wedge element. Thus, by rotating the plane of polarization of a linearly polarized input beam, the relative intensity of the output beams can be adjusted. In some embodiments of the invention, the polarization-modifying element is a polarization-rotating element, e.g., a half-wave plate made from a birefringent material, that is rotatable so as to enable adjustment of the relative intensity of the divergent output beams.

In other embodiments, a higher number of beam-splitting elements are used in order to produce a greater number of output beams. The superposition of greater number of beams allows for more control over the final combined beam profile and enables better approximations to an desired beam profile, For example, the accuracy of an approximation of an ideal top-hat beam profile can be increased using a superposition of a greater number of narrower output beams. The desired number of beam-splitting elements will be application-dependent. It is expected that, in most applications, there will be a tradeoff between the accuracy of the approximation and the simplicity (e.g., low part count) of the beam-shaper, and a suitable beam-shaper can be designed following the guidance provided herein.

In some applications, it will be desirable to modify the polarization of the output beams. For example, measurements of the scatter properties of particles in flow cytometry may be dependent on the polarization of the beams relative to the detector optics. As different particles may scatter light from different parts of the excitation beam, it is desirable that the excitation light be uniformly polarized across the full width of the excitation region. In some embodiments, the output beams are passed through a polarization-modifying element such that the polarization of the component output beams are made equivalent relative to the detector optics. Suitable polarization-modifying elements are those that produce a combination of unpolarized, circularly polarized, or linearly polarized light. In a preferred embodiment, the polarization-modifying element is a polarization-rotating element, such as half-wave plate, oriented to rotate the polarization of each of the divergent beams by 45°, although other polarization-modifying elements will be equally useful.

In a preferred embodiment, the beam-shaper of the present invention is a component of the excitation optics of a flow cytometer. However, a top-hat beam profile can be useful in a variety of applications, and the present invention will be generally useful in applications in which a top-hat beam profile is useful. Other applications in which a top-hat profile, or approximation thereof, is useful include lithography, displays, microscopy, optical disks, and telecommunications. In a flow cytometer, the beam-shaper is useful for reshaping the excitation beam profile to efficiently provide uniform illumination across the flow stream. Thus, aspects of the invention include, but are not limited to, excitation optics for a flow cytometer comprising a beam-shaper of the present invention, a flow cytometer comprising the excitation optics of the present invention, and methods for shaping the excitation light in a flow cytometer.

### BRIEF DESCRIPTION OF THE SEVERAL VIEWS OF THE DRAWINGS

FIG. 1 shows the optical properties of a wedge of birefringent material, as used in the present invention.

FIG. 2 shows the optical elements of a beam-shaper of the present invention comprising one beam-splitting element.

FIG. 3 shows the expected beam intensity profile of a light beam as it passes through the optical elements of the beam-shaper shown in FIG. 2, along with the orientation of the plane of polarization of the beam(s).

FIG. 4 shows the optical elements of a beam-shaper of the present invention comprising two beam-splitting elements.

FIG. 5 shows the expected beam intensity profile of a light beam as it passes through the optical elements of the beam-shaper shown in FIG. 4, along with the orientation of the plane of polarization of the beam(s).

FIG. 6 shows the optical elements of a preferred embodiment of the beam-shaper of the present invention.

FIG. 7 shows a beam-shaper of the present invention as used in a flow cytometer to illuminate the flow stream at a designated spot.

FIG. 8 shows the expected beam intensity profile along the x-axis of a 488 nm beam passed through the shaper shown in FIG. 6.

FIG. 9 shows the empirically determined beam intensity profiles along the x- and y-axes of a 375 nm beam passed through the shaper shown in FIG. 6.

### DETAILED DESCRIPTION OF THE INVENTION

The following definitions are provided for clarity. Unless otherwise indicated, all terms are used as is common in the art. All reference cited herein, both supra and infra, are incorporated herein by reference.

A beam profile refers to the intensity measured along a cross-section of the beam, orthogonal to the direction of propagation.

An “ideal top-hat” beam profile is used herein to refer to a beam profile that is uniform over a specified spot area in at least one profile dimension and has zero intensity outside the spot area. A “top-hat” beam profile is used more broadly herein to refer to an approximation of an ideal top-hat beam profile, i.e., a beam profile that is uniform, or nearly uniform, over a specified spot area in at least one profile dimension, and that falls off rapidly outside the specified spot area. The use of the term “top-hat beam profile” to describe a shaped output beam is not intended to specify a particular level of accuracy of the approximation, as the desired or useable accuracy depends on the intended application, and the present invention enables the construction and use of a beam-shapers suitable for use in a specified application. For example, for some applications, a low accuracy approximation obtained from the superposition of two partially overlapping gaussian beam profiles will be useable. In other applications, an accurate approximation of an ideal top-hat beam profile is desirable, and can be obtained from, for example, the superposition of a higher number of gaussian beam profiles.

Depending on the application, it may be desirable to deliberately deviate from an ideal top-hat beam profile. For example, it may be desirable to create a beam profile that is deliberately non-uniform over the spot area. The present invention enables beam-shapers that provide a wide range of beam profiles; the particular desired beam profile will depend on the application. For ease of discussion, a top-hat beam profile refers herein to profiles that are approximations of an ideal top-hat profile and profiles chosen deliberately to deviate from the ideal top-hat profile.

In some embodiments, a beam-shaper of the present invention produces a beam that has a top-hat profile in one dimension, while not altering the profile in the orthogonal profile axis. For example, using the coordinate system shown in the figures in which the beam propagates along the z-axis, the beam-shaper of example 1 produces a beam having a top-hat profile along the x-axis without modifying the input beam profile along the y-axis. It will be understood that a beam that has a top-hat beam profile in both dimensions can be created using multiple beam-splitting elements oriented appropriately.

As used herein, “a combination of unpolarized, circularly polarized and linearly polarized light” is intended to encompass combinations having any relative proportions of these classes of polarized light, including a zero contribution from at least one of the classes of polarized light. For example, pure linearly polarized light is considered herein to be a combination of unpolarized, circularly polarized and linearly polarized light, wherein the contributions from unpolarized and circularly polarized light are both zero.

Uniaxial Birefringent Crystals

A uniaxial birefringent crystal, such as mica, calcite, crystalline quartz, magnesium chloride or fluoride, or rutile, is characterized by two of three orthogonal crystalline axes possessing the same refractive index and the remaining axis possessing a different refractive index. The two common axes are called the ordinary axes (o-axes) and the dissimilar axis is called the extraordinary axis (e-axis). A crystal is referred to as positive or negative uniaxial depending on whether the refractive index of the extraordinary axis is greater than or less than the ordinary refractive indices, respectively.

The cut of the crystal for the purposes of a birefringent filter element is such that the extraordinary axis, or e-axis, is in the plane of the crystal face onto which optical radiation is incident. This crystal cut is herein referred to as a waveplate. In the waveplate orientation, optical radiation which propagates through the crystal body, is split into two distinct linear polarizations: one which is aligned to the e-axis and one which is aligned to the orthogonal ordinary axis, or o-axis. Because the refractive indices of the e- and o-axes differ, the phase and group velocities of the linearly polarized waves as they travel through the crystal differ. It is common to refer to the axes as fast and slow. However, the correspondence between fast and slow, and ordinary and extraordinary, depends of the sign of the crystal. A positive uniaxial crystal is one in which the e-axis is the slow axis and the o-axis is the fast axis, and a negative uniaxial crystal is one in which the e-axis is the fast axis and the o-axis is the slow axis.

A half-wave plate (λ/2 wave plate) is useful for rotating the plane of polarization of a plane-polarized wave to any other desired plane. If a plane-polarized wave is normally incident on a λ/2 wave plate, and the plane of polarization is at an angle θ with respect to the fast (or slow) axis of the wave plate, then after passing through the plate, the original plane wave will be rotated through an angle 2θ. For example, vertically polarized light can be rotated to become horizontally polarized using a λ/2 wave plate placed in the beam with its fast (or slow) axis 45° to the vertical.

Similarly, as used herein, vertically polarized light can be rotated to become polarized at a angle 45° to the vertical by passing though a λ/2 wave plate placed in the beam with its axis 22.5° to the vertical. Horizontally polarized light passed though this same λ/2 wave plate is rotated such that the final angle of polarization is 45° to the vertical.

A Quarter-wave plate (λ/4 plate) is useful for converting to turn plane-polarized light into circularly polarized light and vice versa. The wave plate is oriented such that an incident plane-polarized wave is at 45° to the fast (or slow) axis of the wave plate.

Zero-order wave plates, both half-wave and quarter wave, are commercially available from a number of sources, such as Red Optronics (Mountainview, Calif.); Lambda Research Optics (Costa Mesa, Calif.); Thorlabs (Newton, N.J.); Edmund Optics (Barrington, N.J.); and JDS Uniphase (Santa Rosa, Calif.).

Focusing lenses are a standard elements well-known in the art. The particular lens design used in the beam-shaper of the present invention will be application dependent, and one of skill in the art will be able to select a suitable focusing lens routinely. A discussion of focusing lenses for use in flow cytometry can be found in, for example, Shapiro, 2003, Practical Flow Cytometry (John Wiley and Sons, Inc. Hoboken, N.J.), incorporated herein by reference.

Description Based on the Figures

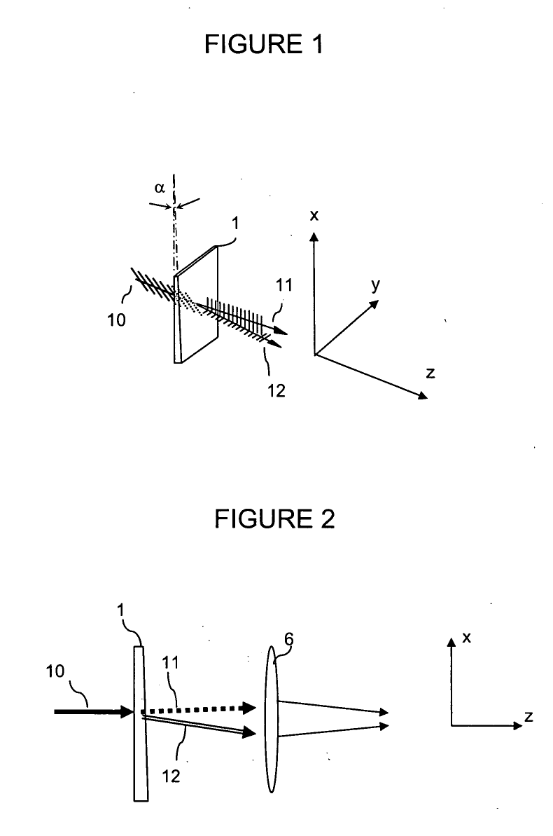

FIG. 1 depicts a beam-splitting element consisting of a wedge element 1 of birefringent material as used in the beam-shaper of the present invention. The direction of inclination or the wedge is along the optical axis of the crystal (i.e., the plate has a wedge-shaped cross section along the optical axis, and constant thickness cross-section in the perpendicular direction). An input light beam 10 passing through the wedge element 1 will be split into two beams of orthogonal polarizations, 11 and 12, propagating at slightly divergent directions. The angular separation between the two output beams 11 and 12 is uniquely determined by the indices of refraction of the birefringent material and the apex angle, α, of the wedge element. The design of a suitable wedge element that will split an input beam into two output beams having a desired angle of divergence is routine in the art.

The intensities of the two output beams 11 and 12 are directly proportional to the projection of the incoming beam 10 polarization onto the polarization planes of the output beams, i.e., onto the axes of the birefringent wedge element. FIG. 1 depicts a preferred embodiment in which input light 10 is linearly polarized and the polarization plane (depicted by cross-hatching) of the input light, which propagates along the z-axis, is 45° relative to x-axis. In this case, the projections of the input beam onto the polarization planes of the wedge element are equal, and the output beams 11 and 12 are of equal intensity. As illustrated schematically, output beams 11 and 12 propagate in slightly divergent directions, diverging along the x-axis, with perpendicular polarizations (depicted by the cross-hatching).

In general, unpolarized, circularly polarized, or 45° (relative to the x-axis) linearly polarized input beams have equal projections onto the polarization planes of the wedge element and will split into two output beams of equal intensities. As is apparent to one skilled in the art, any input light beam can be made into a combination of unpolarized, circularly polarized and 45° linearly polarized light using, for example, an optical element of a birefringent material, such as a half-wave plate. Thus, any input beam can be modified such that, by passing the beam through the wedge 1 of birefringent material, it is split into two linearly polarized beams of equal intensities.

Similarly, the relative intensities of the output beams may be modified by adjusting the input light beam polarization such that the projections of the input beam onto the polarization planes of the wedge element are unequal. For example, the plane of polarization of a linearly polarized input beam can rotated relative to the axes of the wedge element to obtain any desired relative intensities of the output beams.

FIG. 2 depicts an embodiment of a beam-shaper in accordance with the present invention comprising a beam-splitting element 1 consisting of a wedge element of birefringent material, and a focusing lens 6.

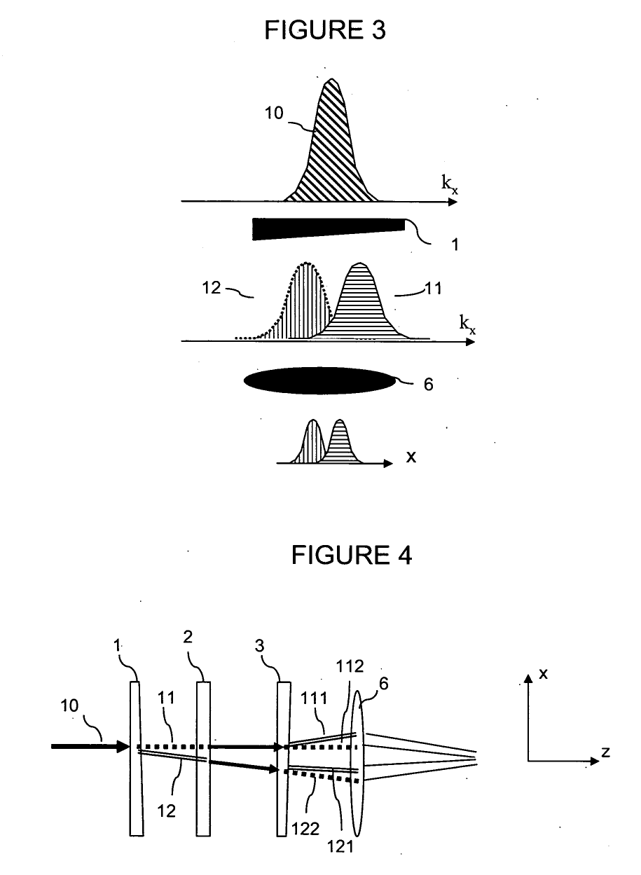

Input beam 10, assumed to be, or to have been modified to be, some combination of unpolarized, circularly polarized and 45° linearly polarized light, is split into two linearly polarized beams 11 and 12 of equal intensities and with orthogonal polarization planes, by passing the beam through the wedge element 1. Output beams 11 and 12 diverge along the x-axis. The beam profile of the combined beam (shaped beam) comprising the two divergent, but overlapping, output beams has a broadened beam profile along the x-axis, as shown schematically in FIG. 3, described below. The shaped beam is passed through focusing lens 6 in order to focus the shaped beam to the size of the desired illumination spot.

The evolution of the beam shape in angular space as it passes through the optical elements shown in FIG. 2 is illustrated schematically in FIG. 3. Each intensity profile depicts the intensity of the beam in a cross-section through the center of the beam along the x-axis of FIGS. 1 and 2, which is the axis along which the beam is split by the beam-shaper. In the first two (from the top) intensity profiles, the beam intensity along this cross-section is plotted schematically on the ordinate (vertical axis), with the angle of dispersion (kₓ) along this cross-section shown on the abscissa (horizontal axis). The intensity profiles shown correspond to the initial beam and the shaped beams after each optical element, with the direction of polarization depicted by the hash-lines within the intensity profiles. For clarity, the optical elements are shown in cross section along the x-axis, with the direction of light propagation (the z-axis of FIGS. 1 and 2) running from top to bottom. Focusing lens 6 focus the beams to a specific spot size, thus converting the beam profile in angular space into physical space, and the intensity profile following focusing lens 6 is plotted schematically with physical distance, rather than angle of dispersion, on the abscissa.

The beam profiles shown in FIG. 3 are numbered to correspond to the numbering of the beams shown in FIG. 2. Thus, profile 10 depicts schematically an intensity profile and direction of polarization of beam 10 shown in FIG. 2, and so forth.

Note that divergent beams exiting wedge element 1 are polarized in directions perpendicular to each other. The orthogonal polarizations minimize undesired coherent interferences between the beams. This property of the beam-shapers of the present invention represents a significant advantage over previously described beam-shapers.

FIG. 4 depicts a preferred embodiment of a top-hat beam-shaper in accordance with the present invention comprising a beam-splitting element 1, a polarization-modifying element 2, and a second beam-splitting element 3, wherein beam-splitting elements 1 and 3 are wedge elements of a birefringent material and polarization-modifying element 2 is a polarization-rotating element consisting of a half-wave plate. Also depicted in FIG. 4 is a focusing lens 6 that is used focus the shaped beam to the size of the desired illumination spot.

The input beam 10, assumed to be, or to have been modified to be, a combination of unpolarized, circularly polarized and 45° linearly polarized light, is split into two linearly polarized beams 11 and 12 of equal intensities and with orthogonal polarization planes, by passing the beam through the wedge element 1. Output beams 11 and 12 diverge along the x-axis. Output beams 11 and 12 then pass through a half-wave plate 2, which, in one embodiment, is oriented such that the plane of polarization of each of the two output beams is rotated 45°. After the rotation, the two perpendicularly polarized beams remain perpendicularly polarized, and the plane of polarization of each is 45° relative to the x-axis. The two rotated output beams then pass through the second wedge element 3, which splits each of the two beams 11 and 12 into two divergent, linearly polarized beams of equal intensities and with orthogonal polarization planes, resulting in four output beams 111, 112, 121, and 122 that diverge along the x-axis. The beam profile of the combined beam (shaped beam) comprising the four divergent, but overlapping, output beams has a top-hat beam profile along the x-axis, as shown in more detail, below. The shaped beam, which comprises divergent component beams, is passed through focusing lens 6 in order to focus the shaped beam to the size of the desired illumination spot.

In the embodiment of the beam-shaper of FIG. 4 described above, half-wave plate 2 is oriented such that the plane of polarization of each of the two output beams 11 and 12 is 45° relative to the optical axis of wedge element 3. Consequently, the projections of the output beams 11 and 12 onto the polarization planes of wedge element 3 are equal, which results in output beams 11 and 12 being split into equal intensity output beams 111 and 112 and 121 and 122, respectively. Alternatively, the orientation of half-wave plate 2 is adjusted such that the projections of the output beams 11 and 12 onto the polarization planes of wedge element 3 are unequal, which alters the relative intensity of output beams 111 and 112 and of output beams 121 and 122. As discussed further, below, this adjustability provides flexibility in the beam profile of final combined beam. The simple adjustability of the beam-shaper of the present invention represents a significant advantage over previously described beam-shapers.

In another embodiment, element 2 is a quarter-wave plate that converts the linearly polarized output beams 11 and 12 into circularly polarized light, which results in equal projections of the output beams 11 and 12 onto the polarization planes of wedge element 3. It will be clear to one of skill in the art that other polarization-modifying elements can be used, such a diffraction grating elements, to convert the linearly polarized light to some combination of unpolarized, circularly polarized and 45° linearly polarized light.

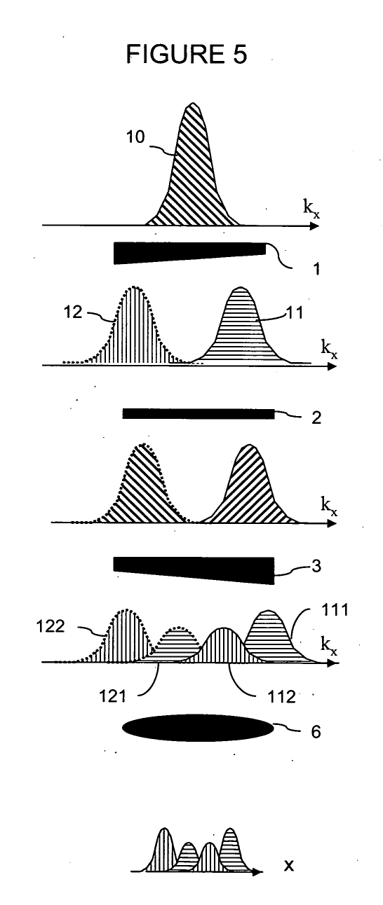

The evolution of the beam shape in angular space as it passes through the optical elements shown in FIG. 4 is illustrated schematically in FIG. 5. Each intensity profile depicts the intensity of the beam in a cross-section through the center of the beam along the x-axis of FIG. 4, which is the axis along which the beam is split by the beam-shaper. In the first four intensity profiles, the beam intensity along this cross-section is plotted schematically on the ordinate (vertical axis), with the angle of dispersion (kₓ) along this cross-section shown on the abscissa (horizontal axis). The intensity profiles shown correspond to the initial beam and the shaped beam(s) after each optical element, with the direction of polarization depicted by the hash-lines within the intensity profile. For clarity, the optical elements are shown in cross section along the x-axis, with the direction of light propagation (the z-axis of FIG. 4) running from top to bottom. Focusing lens 6 focus the beams to a specific spot size, thus converting the top-hat beam profile in angular space into physical space, and the intensity profile following focusing lens 6 is plotted schematically with physical distance, rather than angle of dispersion, on the abscissa.

The beam profiles are numbered to correspond to the numbering of the beams shown in FIG. 4. Thus, profile 10 depicts schematically an intensity profile and direction of polarization of beam 10 shown in FIG. 4, and so forth.

Note that due to the orthogonal polarizations of the two input beams, the intensities of the beams exiting wedge element 3 are symmetrically distributed about the center propagation direction. In addition, adjacent beams exiting wedge element 3 are polarized in directions perpendicular to each other. The orthogonal polarizations minimize undesired coherent interferences between adjacent beams.

It will be apparent to those skilled in the art that the relative intensities of the center beams 121 and 112 to those of the side beams 122 and 111 are uniquely determined by the orientation of optical axis of half-wave plate 2 with respect to the incoming beam polarizations. By rotating the optical axis of the half-wave plate, the relative intensity of inner to outer beams, as split by wedge element 3 can be adjusted. Thus the shape of the combined exit beams can be adjusted, without loosing its symmetry.

As shown in FIG. 5, the output light leaving wedge element 3 can be described in angular space as four beams having identical shapes but different amplitudes, slightly offset from each other. By optimizing the beam separations using the wedge elements 1 and 3 and the relative amplitude of the beams using the half-wave plate 2, a top-hat beam can be readily created from the superposition of the four beams. The resulted top-hat beam profile is in the angular space. Focusing lens 6 is used to focus the beams to a specific spot size, i.e., converting the top-hat beam profile in angular space into the physical space.

Unlike conventional diffractive or refractive beam-shapers, the performance of the present invention is much less sensitive to the wave front distortion of the incoming beam, due to the polarization orthogonality of the adjacent components in the top-hat. Any imperfection of the incoming beam shape can be further compensated by adjusting the relative amplitude of the individual components in the top-hat by half-wave plate 2. Further, by using achromatic polarization optics, such as those made of magnesium fluoride, and zero-order wave plates, the device can be made to function at multiple wavelengths, as shown in the example, below.

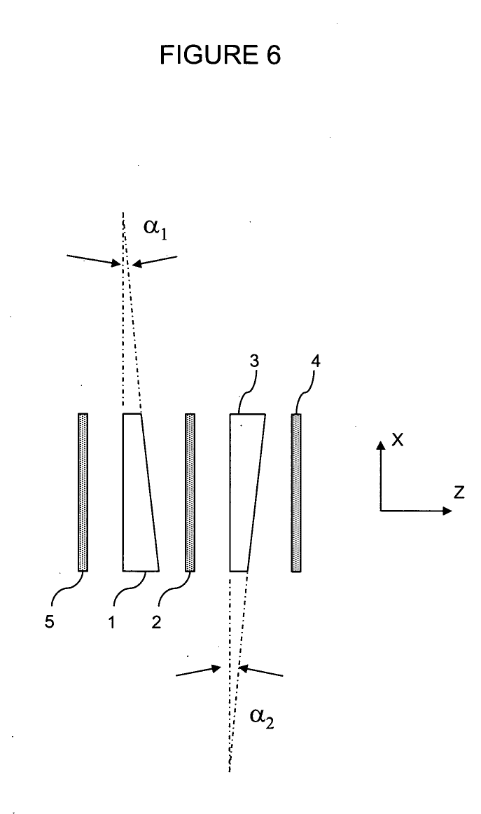

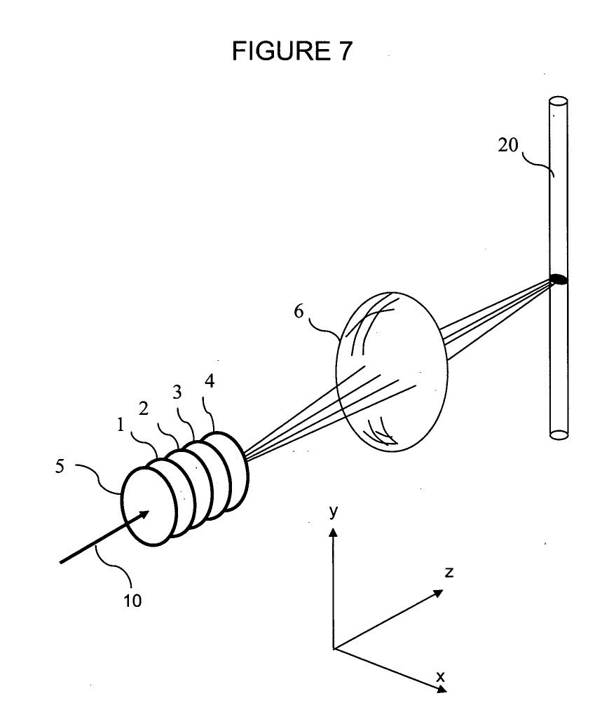

FIGS. 6 and 7 depict a preferred beam-shaper for use in a flow cytometer. The optics were designed for use with a diode laser that emits an oval-shaped divergent beam having an aspect ratio of 10×18 (y-axis x x-axis), such that the shaped beam can be focused, using focusing lens 6, onto a 10 micron (y-axis) spot size impinging on the flow stream 20 of a flow cytometer (elements 6 and 20 shown in FIG. 7).

Referring to FIG. 6, the elements are oriented relative to the axes as shown in the previous figures, and the direction of the initial input beam (beam 10 in FIG. 7) is along the z-axis, and passes through element 5, 1, 2, 3, and 4, and 6 (shown in FIG. 7), in that order.

Element 5 is a half-wave plate, preferably zero order, oriented in a plane perpendicular to the z-axis such that the angle between the optical axis and the x-axis is 22.5°. Element 5 is used to convert an input beam into a beam linearly polarized at a 45° angle relative to the y-axis such that the projections of the beam onto the polarization axes of the following wedge element are equal. This element is optional and may not be needed if the input beam 10 is an appropriate combination of unpolarized, circularly polarized and 45° linearly polarized light. For example, some lasers produce vertically polarized light, and may be used directly by an appropriate rotation of the laser itself. However, it may be desirable to use element 5 to rotate the plane of polarization of the laser light for convenience and accuracy of rotation.

Element 1 is a quartz wedge having α₁ equal to 1.569°, oriented such that the surface on which the input beam impinges is in a plane perpendicular to the z-axis, and such that the angle between the optical axis and the x-axis is 0°. Element 1 splits beam 10 into divergent beams 11 and 12, polarized along the X- and Y-axes, respectively, as shown in FIG. 3.

Element 2 is a half-wave plate, preferably zero order, oriented in a plane perpendicular to the z-axis such that the angle between the optical axis and the x-axis is 23.47°. This angle preferably is adjustable in order to allow for adjustments in the relative intensity of the component beams, as described above. Element 2 rotates the polarization of beams 11 and 12 leaving wedge element 1, which are polarized along the X- and Y-axes, respectively, to a 45° angle relative to the x-axis.

Element 3 is a quartz wedge having α₂ equal to 0.807°, oriented such that the surface on which the input beams impinge is in a plane perpendicular to the z-axis, and such that the angle between the optical axis and the x-axis is 0°. Element 3 splits beam 11 into divergent beams 111 and 112, polarized along the X- and Y-axes, respectively, and splits beam 12 into divergent beams 121 and 122, polarized along the X- and Y-axes, respectively, as shown in FIG. 3.

Element 4 is a half-wave plate, preferably zero order, oriented in a plane perpendicular to the z-axis such that the angle between the optical axis and the X axis is 22.5°. Element 4 rotates the polarization of beams 111 and 112, polarized along the X- and Y-axes, respectively, and beams 121 and 122, polarized along the X- and Y-axes, respectively, to a 45° angle relative to the x-axis. Because the measurement of the scatter properties of particles using a flow cytometer typically is sensitive to the polarization of the excitation beam, it is desirable to rotate the polarization of each of the component beams to a 45° angle relative to the optical axis of detection.

Element 6, shown in FIG. 7, is a 50 mm focusing lens designed to focus the divergent beams 111, 112, 121, and 122 onto the flow stream 20.

When used with a focusing lens 6, as shown in FIG. 7, the spacing between the plates, the plate thicknesses, and the wedge thicknesses are not critical, although the dimensions preferably are chosen to achieve a compact size and mechanical rigidity. Furthermore, the spacing between the beam-shaper and the focusing lens is not critical.

As shown in FIG. 7, the beam-shaper is oriented such that the excitation input beam is reshaped into a top-hat profile along an axis perpendicular to the direction of the flow stream 20 in order to uniformly illuminate the full width of the flow stream. Typically, it is desirable to focus the beam along the direction of the flow as narrowly as practical to maximize the intensity of the excitation light. Thus, it is desirable to use a beam-shaper that provides a top-hat beam profile along one axis, while leaving the orthogonal axis unshaped, as in the beam-shaper of FIG. 7. It will be clear to one of skill in the art that two-dimensional reshaping will be desirable in other applications, and that such reshaping can be carried out using beam-shaping elements as described herein, oriented to reshape along each axis independently.

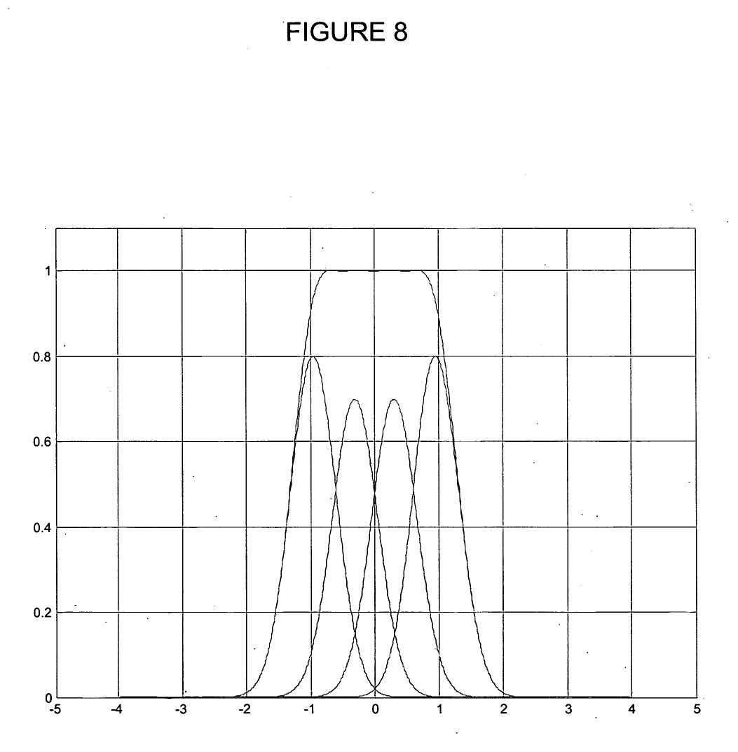

FIG. 8 shows the expected beam profile along the x-axis of a gaussian input beam transformed using the beam-shaper shown in FIG. 6 and focused by focusing lens 6. The profiles of each of the divergent beams 111, 112, 121, and 122 are shown together with the combined beam resulting from the superposition of the component beams. The units on the abscissa are in increments of the diameter of the input gaussian beam at 1/e² maximum intensity, and the units on the ordinate are arbitrary intensity units. The top-hat combined beam profile exhibits a 0.1% ripple over a spot size 1.5 diameters in size.

### EXAMPLES

The following examples is put forth so as to provide those of ordinary skill in the art with a complete disclosure and description of how to make and use the present invention, and are not intended to limit the scope of what the inventors regard as their invention nor are they intended to represent that the experiments below are all or the only experiments performed.

### Example 1

### Beam-Shaper for Flow Cytometry

A beam-shaper essentially as shown in FIGS. 6 and 7 was made and tested. Half-wave plates and wedge elements meeting the following specifications were obtained from Red Optronics (Mountainview, Calif.), the wedge elements as custom ordered components:
Element dimensions: 9.9±0.1 mm diameter
Wavefront distortion <λ/5 @ 488 nm
Coating: R<0.2% on all surfaces
Elements 4, 2, and 5: zero order half-wave plates
   Retardation tolerance: <λ/500
   Parallelism: <1 arc second
   no epoxy in optical path
Wedge element 1: α₁=1.569°±10 arc seconds
Wedge element 2: α₂=0.807°±10 arc seconds

The beam-shaper was assembled such that all angles were within 0.5° of the specified angles. Element 2, oriented in a plane perpendicular to the z-axis, was empirically adjusted to give optimum results, which were obtained, in this case, at an angle between the optical axis and the x-axis of 23.47°.

The beam-shaper was tested using an input beam from a 375 nm UV laser diode that emits an oval-shaped divergent beam having an aspect ratio of 10×18. The laser diode was oriented such that 10×18 aspect ratio was y-axis x x-axis. Prior to shaping, the input beam was first passed though an aspheric collimating lens.

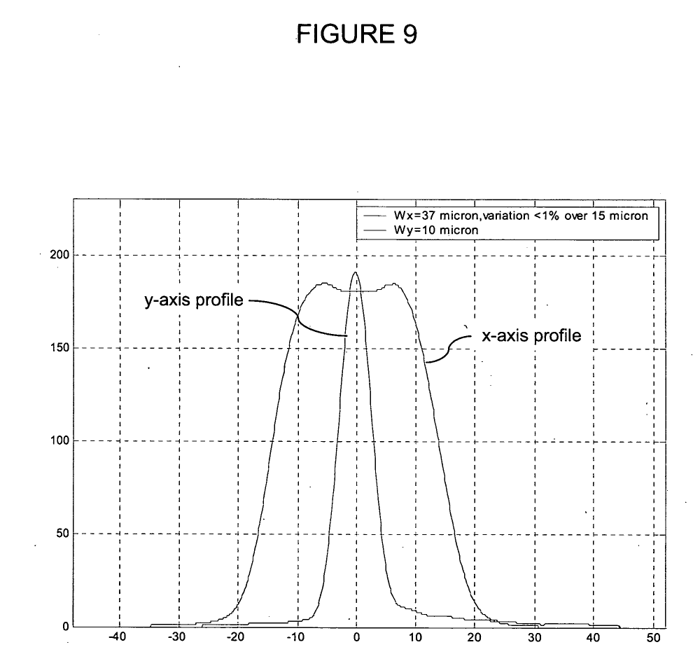

The profile of the beam was measured at the focal plane of the 50 mm focusing lens, corresponding to the placement of the flow stream in a flow cytometer. The measured intensity profiles along the x-axis (shaped beam profile) and the y-axis are shown in FIG. 9. The units on the abscissa are microns, and the units on the ordinate are arbitrary intensity units.

For comparison to with the shaped beam profile described below, if this unshaped input beam were focused using focusing lens 6, the intensity profile at the focal plane would be essentially gaussian along both the x- and y-axes, with beam widths at 1/e² maximum intensity of 18 and 10 microns, respectively.

As shown in FIG. 9, the output beam along the y-axis (unshaped direction) retains the essentially gaussian profile of the input beam with a diameter at 1/e² maximum intensity of 10 microns. The beam profile of the beam along the x-axis is reshaped into a top-hat profile with a width of 37 microns, and exhibits a nearly uniform (<1% variation) over a 15 microns region.

For comparison, in order to obtain using a gaussian beam a center region of 15 microns over which the beam has <1% variation, the gaussian beam would have a width of greater than 110 microns. The use of such a beam to illuminate the flow stream in a flow cytometer would result in the majority of the energy being wasted. The beam-shaper of the present invention enables nearly uniform illumination of the flow stream with little wasted energy.

It should be noted that the empirical results shown in FIG. 9 were obtained with a 375 nm UV laser, whereas the beam-shaper optics were specified for use with a 488 nm light source. A comparison of the empirical results to the expected results using a 488 nm input beam shown in FIG. 8 demonstrates that the beam-shaper is relatively insensitive to the wavelength of the input beam and can be used with a range of wavelengths. This property of the beam-shaper of the present invention provides significant advantages for use in multi-laser instruments, as a single beam-shaper can be used with the multiple excitation frequencies.

### Example 2

### Beam-Splitter Design

The present example describes the design of beam-shaper of the present invention suitable for a specified application.

In overview, the design of a beam-shaper is carried out by first expressing the intensity profile of the combined output beam as a function of the intensity profile of the input beam and the separation angles of beam-splitting elements, and then optimizing this function to obtain the desired beam profile. Typically, the intensity profile of the input beam is fixed by the choice of the light source, so that in the optimization of the intensity profile of the combined output beam, only the separation angles of beam-splitting elements are treated as input variables. However, if the intensity profile of the input beam can be varied, optimization can be carried out over both the input intensity profile and the angle parameters.

Optimization of the intensity profile, expressed as a function of the input intensity profile and angle parameters, can be carried out empirically or, preferably, using mathematical algorithms, typically implemented in software, as is well known in the art. Having obtained separation angles for the beam-splitting elements from the optimization of the intensity profile function, suitable wedge elements having apex angles that provide the desired separation angles are designed routinely following standard optical design methods.

In preferred embodiments, the beam-shaper of the present invention is used in conjunction with a focusing lens to focus the output beam to desired spot size. However, the beam-shaper can be used either without subsequent focusing of the image. The design of the beam-shaper depends on the ultimate use and, thus, the methods are described below for each case separately.

I. For Use with a Focusing Lens

It is assumed that the combined output beam will be focused using a focusing lens having a focal distance f. Let I₀(x) denote the intensity profile of the input beam focused by a focusing lens having a focal distance f, where x is perpendicular to the direction of beam propagation.

a. Beam Shaper with a Single Beam-Splitting Element

The beam-shaper containing a single beam-splitting element is shown in FIG. 2. It is assumed that that a single wedge element is oriented such that the output beams 11 and 12 diverge along the x-axis with a separation angle θ.

The intensity profile of the superposition of the focused output beams, denoted I₁(x), can be expressed as follows:
I₁(x)=I₀(x+δ)+I₀(x−δ)
where

δ=f·θ/2, and

f is the focal length of the focusing lens.

The intensity profile of the focused combined output beam is optimized to obtain the desired profile, as described above.

b. Beam-Shaper with Multiple Beam-Splitting Elements

The design of beam-shapers comprising a plurality of beam-splitting elements is described with reference to the beam-shaper of FIG. 4 having two beam-splitting elements, 1 and 3, and a polarization-rotating element 2. The design of beam-shapers comprising a greater number of beam-splitting elements is carried out analogously.

The intensity profile of the superposition of the focused output beams, denoted I₁(x), can be expressed as follows:
I₁(x)=r·I₀(x+δ₁)+(1−r)·I₀(x+δ₂)+(1−r)·I₀(x+δ₃)+r·I₀(x+δ4),
where
δ₁=f·(θ₁+θ₂)/2,
δ₂=f·(θ₁−θ₂)/2
δ₃=f·(−θ₁+θ₂)/2
δ₄=f·(−θ₁−θ₂)/2
f is the focal length of the focusing lens
θ₁ is the separation angle of the wedge element 1,
θ₂ is the separation angle of the wedge element 3, and
r is the fraction projection of the output beams 11 and 12 on the axes of the wedge element 3, which is a function of the orientation of the polarization-rotating element 2.

The intensity profile of the focused combined output beam is optimized to obtain the desired profile, essentially as described above. In this case, the orientation of polarization-rotating element 2 is an additional parameter that can be varied to obtain the desired beam profile.

Note that the intensities of the beams exiting wedge element 3 are symmetrically distributed about the center propagation direction and that the intensities of the inner beams relative to the outer beams (beam 121 compared to beam 122 and beam 112 compared to beam 121) are the same. Thus, rotating the polarization-rotating element 2 alters the relative intensities of the two outer beams compared to the two inner beams in a symmetrical manner.

II. For Use without a Focusing Lens

The beam-shaper of the present invention can be used without subsequent focusing of the combined output beam. However, because the component output beams are diverging, a combined output beam having the desired beam profile, which depends on the degree of overlap of the component output beams, will be present only at a single target distance from the beam-shaper. At distances closer than the target distance, the component beams will overlap excessively, and at distances farther than the target distance, the component beams will have diverged too much. Thus, for use without a focusing lens, the beam-shaper is designed such that the desired beam profile is produced at a given target distance.

Let I₀(x) denote the intensity profile of the input beam, where x is perpendicular to the direction of beam propagation.

a. Beam-Shaper with a Single Beam-Splitting Element

The beam-shaper containing a single beam-splitting element is shown in FIG. 2. Focusing lens 6, also shown in FIG. 2, is ignored in the following discussion. It is assumed that that a single wedge element is oriented such that the output beams 11 and 12 diverge along the x-axis with a separation angle θ.

The intensity profile of the superposition of the output beams at a target position located a distance d from the wedge element can be expressed as follows:
I₁(x)=I₀(x+δ)+I₀(x−δ),
where
δ=(d·θ)/2.

The intensity profile of the focused combined output beam is optimized to obtain the desired profile, as described above.

b. Beam-Shaper with Multiple Beam-Splitting Elements

The design of beam-shapers comprising a plurality of beam-splitting elements is described with reference to the beam-shaper of FIG. 4 having two beam-splitting elements, 1 and 3, and a polarization-rotating element 2. Focusing lens 6, also shown in FIG. 4, is ignored in the following discussion) The design of beam-shapers comprising a greater number of beam-splitting elements is carried out analogously.

The intensity profile of the superposition of the output beams at a target position located a distance d₂ from wedge element 3 can be expressed as follows:
I₁(x)=r·I₀(x+δ₁+δ₂)+(1−r)·I₀(x+δ₁−δ₂)+(1−r)·I₀(x−δ₁+δ₂)+(1−r)·I₀(x−δ₁−δ₂),
where
δ₁=(d₁·θ₁)/2,
δ₂=(d₂·θ₂)/2
d₁ is the distance from the wedge element 1 to wedge element 3,
d₂ is the distance from the wedge element 3 to the target position,
θ₁ is the separation angle of the wedge element 1,
θ₂ is the separation angle of the wedge element 3, and
r is the fraction projection of the output beams 11 and 12 on the axes of the wedge element 3, which is a function of the orientation of the polarization-rotating element 2.

The intensity profile of the focused combined output beam is optimized to obtain the desired profile, essentially as described above. Again, as noted above, the orientation of polarization-rotating element 2 is an additional parameter that can be varied to obtain the desired beam profile.

It should be noted that for use without a focusing lens, the distance between the beam-splitting elements is an important design parameter, which is not the case when a focusing lens is used.

I claim:

1. Beam-shaping optics for transforming an input light beam; comprising:
a) a first beam-splitting element consisting of a wedge of birefringent material, oriented such that said input light beam is split into two divergent output beams having overlapping intensity profiles; and
b) a focusing element.

2. A method of shaping an input light beam; comprising:
a) passing said input light beam through a first beam-splitting element consisting of a wedge of birefringent material, oriented such that said input light beam is split into two divergent output beams having overlapping intensity profiles; and
b) focusing said output beams.

3. A beam-shaper for transforming an input light beam having an intensity profile that is approximately gaussian into an output light beam having an intensity profile that is essentially uniform over a given spot; comprising:
a) a first beam-splitting element oriented such that said input light beam is split into two intermediate beams of polarized light having divergent pathways, such that the polarization of the intermediate beams is at 90 degrees to each other;
b) a polarization-modifying element oriented such that the polarization of each of said intermediate beams is modified to be a combination of unpolarized, circularly polarized and linearly polarized light; and
c) a second beam-splitting element oriented such that said each of said intermediate beams is split into two output beams having divergent pathways, such that the polarization of the output beams is at 90 degrees to each other; wherein a combined beam resulting from the superposition of the output beams exhibits an intensity profile that is essentially uniform over said given spot.

4. A beam-shaper of claim 3, wherein said first and second beam-splitting elements each consist of a wedge of a birefringent material.

5. A beam-shaper of claim 4, wherein said polarization-modifying element is a polarization-rotating element.

6. A beam-shaper of claim 5, wherein said polarization-rotating element is a half-wave plate.

7. A beam-shaper of claim 4, additionally comprising a final polarization-modifying element oriented to modify said output light beam to be a combination of unpolarized, circularly polarized and linearly polarized light.

8. A beam-shaper of claim 4, additionally comprising a initial polarization-modifying element oriented to modify said input light beam to be a combination of unpolarized, circularly polarized and linearly polarized light, wherein the plane of polarization of said linearly polarized light is 45 degrees relative to the optical axis of said first beam-splitting element.

9. A method of shaping an input light beam having an intensity profile that is approximately gaussian into an output light beam having an intensity profile that is essentially uniform over a given spot; comprising:
a) passing said input light beam through a first beam-splitting element oriented such that said input light beam is split into two intermediate beams of polarized light having divergent pathways, such that the polarization of the intermediate beams is at 90 degrees to each other;
b) passing said intermediate beams though a polarization-modifying element oriented such that the polarization of each of said intermediate beams is modified to be a combination of unpolarized, circularly polarized and linearly polarized light; and
c) passing said intermediate beams through a second beam-splitting element oriented such that said each of said intermediate beams is split into two output beams having divergent pathways, such that the polarization of the output beams is at 90 degrees to each other;
wherein a combined beam resulting from the superposition of the output beams exhibits an intensity profile that is essentially uniform over said given spot.

10. The method of claim 9, wherein said first and second beam-splitting elements each consist of a wedge of a birefringent material.

11. The method of claim 10, wherein said polarization-modifying element is a polarization-rotating element.

12. The method of claim 11, wherein said polarization-rotating element is a half-wave plate.

13. The method of claim 10, wherein said output beams are passed through a final polarization-modifying element oriented to modify said output light beam to be a combination of unpolarized, circularly polarized and linearly polarized light.

14. The method of claim 10, wherein said input light beam is first passed through an initial polarization-modifying element oriented to modify said input light beam to be a combination of unpolarized, circularly polarized and linearly polarized light, wherein the plane of polarization of said linearly polarized light is 45 degrees relative to the optical axis of said first beam splitting element.

15. Flow cytometer excitation optics comprising a beam-shaper of claim 1.

16. Flow cytometer excitation optics comprising a beam-shaper of claim 2.

17. Flow cytometer excitation optics comprising a beam-shaper of claim 3.

18. Flow cytometer excitation optics comprising a beam-shaper of claim 4.

19. Flow cytometer excitation optics comprising a beam-shaper of claim 5.

20. Flow cytometer excitation optics comprising a beam-shaper of claim 6.

21. Flow cytometer excitation optics comprising a beam-shaper of claim 7.

22. Flow cytometer excitation optics comprising a beam-shaper of claim 8.

23. A flow cytometer comprising a the flow cytometer excitation optics of claim 15.

24. A flow cytometer comprising a the flow cytometer excitation optics of claim 16.

25. A flow cytometer comprising a the flow cytometer excitation optics of claim 17.

26. A flow cytometer comprising a the flow cytometer excitation optics of claim 18.

27. A flow cytometer comprising a the flow cytometer excitation optics of claim 19.

28. A flow cytometer comprising a the flow cytometer excitation optics of claim 20.

29. A flow cytometer comprising a the flow cytometer excitation optics of claim 21.

30. A flow cytometer comprising a the flow cytometer excitation optics of claim 22.
